(19) United States
(12) Patent Application Publication
(10) Pub. No.: US 2010/0057787 A1
(43) Pub. Date: Mar. 4, 2010

(54) METHOD, SYSTEM, AND COMPUTER PROGRAM PRODUCT FOR CLONING OF DISTRIBUTED AND STATEFUL SYSTEMS

(75) Inventors: Thomas H. Gnech, Ammerbuch (DE); Steffen Koenig, Heidelberg (DE); Oliver Petrik, Stuttgart (DE); Holger J. Scheller, Meckesheim (DE)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/200,001

(22) Filed: Aug. 28, 2008

(51) Int. Cl. G06F 12/16; G06F 17/30

(52) U.S. Cl. 707/204; 707/E17.005

(57) ABSTRACT

A method, system, and computer program product for implementing cloning operations in a distributed computing system are provided. The method includes preparing a database component of the system for a cloning operation. The preparation includes stopping activities occurring on the system except for the cloning operation, identifying current system state information from the database component and an application component of the system, and creating a self-contained system image of the database component that includes an image file of the database component and the current system state information. The method also includes restoring the system state of the application component by loading the self-contained system image on the database component, installing the image file of the database component on the database component, and updating the system state information on the database component and the application component from the self-contained system image, prior to restarting the system.

### BACKGROUND OF THE INVENTION

The present disclosure relates generally to distributed computing systems and, in particular, to a method, system, and computer program product for cloning of distributed and stateful systems.

Distributed computing systems typically involve the use of a combination of different processors (e.g., servers) for data and application logic, which processors communicate, e.g., over one or more networks. In a distributed computing environment, the combination of application context (e.g., application-related information such as log file location, file system structure and customization), logistics context (e.g., application-related local customization, such as information about file systems, configuration, etc.), and run time context (e.g., information produced during run time, such as log files and other information describing the progress of system use) collectively define a system state. The system state typically changes steadily during system operation, where at any point in time, the application context, logistics context, and run time context are consistent. When the system operation discontinues, the system state is ‘frozen’ and saves the latest condition of the system. When the system is then restarted, it uses this latest condition to continue operation as if there were no disruption (e.g., rather than resetting the system and starting it from ‘scratch’).

Distributed systems have a state representation on each of the servers that form part of that system. In order to provide such a system with a consistent start condition after a cloning operation, all of the state information that exists prior to the cloning operation needs to be available. The application logic is stateless and can be recreated for every new clone from ‘scratch.’ However, the data, residing in a database, has to be saved prior to cloning and then restored for the new clone. Contextual data, which resides partly in the database and partly on the application side, also needs to be saved and restored for the new clone. One common approach is to separately handle the two individual pieces (i.e., the database content and the application content) by moving them to the target servers where they are then restored individually. This process is time consuming and prone to errors.

In addition, another drawback to cloning of distributed stateful systems is shown in FIG. 1. Such cloning techniques typically require a one-to-one relationship between each application image (e.g., application image A1 of application images A1 through An) and each single product image (e.g., product image P1 of images P1 through Pn) of a product family. For example, P1 through Pn may represent different versions of a single product or may represent different product flavors. As shown in FIG. 1, images of multiple products or product flavors (P1-Pn) each run with a known application image (of images A1-An). For example, P1 has a direct one-to-one correspondence with, and runs only with, A1. As can be seen in FIG. 1, the technique requires a doubled cloning effort resulting in dramatically increased storage requirements. In addition, this technique requires consistency management for the relationships between each of the products and applications (represented in FIG. 1 as P*-A*), which can be an added burden.

What is needed, therefore, is more efficient way to implement cloning operations in distributed systems.

### BRIEF SUMMARY OF THE INVENTION

Embodiments of the invention include a method of implementing cloning operations in a distributed computing system. The method includes preparing a database component of the system for a cloning operation. The preparation includes stopping activities occurring on the system except for the cloning operation, identifying current system state information from the database component and an application component of the system, and creating a self-contained system image of the database component that includes an image file of the database component and the current system state information. The method also includes restoring the system state of the application component by loading the self-contained system image on the database component, installing the image file of the database component on the database component, and updating the system state information on the database component and the application component from the self-contained system image, prior to restarting the system.

Additional embodiments include a system for implementing cloning operations in a distributed computing system. The system includes a first processor implementing a database component, a second processor in communication with the first processor and implementing an application component, and a cloning application executing on a computer device in communication with the first and second processors. The cloning application implements a method. The method includes preparing the database component of the system for a cloning operation. The preparation includes stopping activities occurring on the system except for the cloning operation, identifying current system state information from the database component and the application component of the system, and creating a self-contained system image of the database component that includes an image file of the database component and the current system state information. The method also includes restoring the system state of the application component by loading the self-contained system image on the database component, installing the image file of the database component on the database component, and updating the system state information on the database component and the application component from the self-contained system image, prior to restarting the system.

Further embodiments include a computer program product for implementing cloning operations in a distributed computing system. The computer program product includes a storage medium with computer-executable program code embodied thereon. The program code includes instructions for implementing a method. The method includes preparing a database component of the system for a cloning operation. The preparation includes stopping activities occurring on the system except for the cloning operation, identifying current system state information from the database component and an application component of the system, and creating a self-contained system image of the database component that includes an image file of the database component and the current system state information. The method also includes restoring the system state of the application component by loading the self-contained system image on the database component, installing the image file of the database component on the database component, and updating the system state information on the database component and the application component from the self-contained system image, prior to restarting the system.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram illustrating conventional product image-to-application image relationships used in cloning operations of a distributed and stateful system;

FIG. 2 is a block diagram of a distributed system for performing cloning operations in an exemplary embodiment;

FIG. 3 is a flow diagram describing a process for implementing cloning operations in the distributed system of FIG. 2 in an exemplary embodiment;

FIG. 4 illustrates a block diagram describing a flow of operations performed in implementing cloning in the distributed system of FIG. 2 in an exemplary embodiment; and

FIGS. 5A through 5C illustrate example applications of the exemplary cloning system of FIG. 2 in which FIG. 5A describes automated provisioning of the system and FIGS. 5B-5C describe re-creation of the system state in an exemplary embodiment.

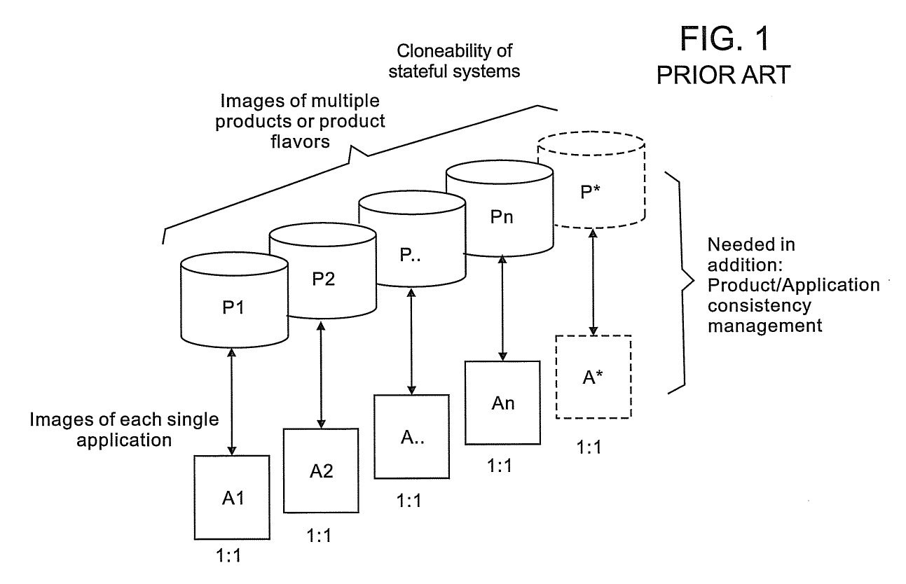

The detailed description explains the preferred embodiments of the invention, together with advantages and features, by way of example with reference to the drawings.

### DETAILED DESCRIPTION OF THE INVENTION

Exemplary embodiments describe an efficient way to implement cloning operations in a distributed computing system environment. A source system (first processor is prepared for the cloning operation by identifying various system state information, building an image from the source system, and creating a self-contained system image therefrom. The self-contained system image is then installed on a target system (second processor) to restore the system state information resulting from the cloning operation. These features, and others, will now be described.

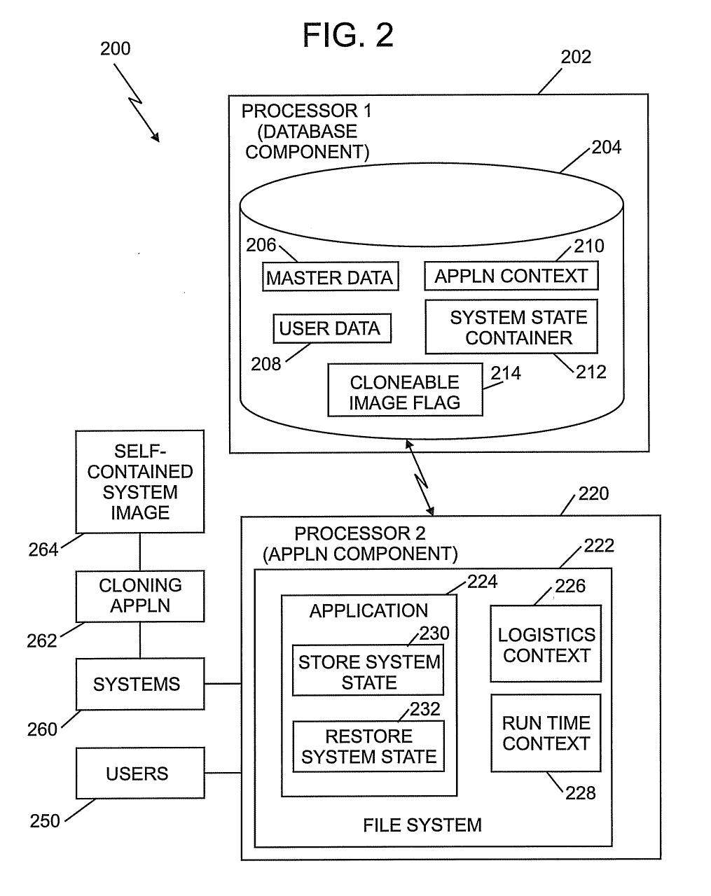

Turning now to FIG. 2, an exemplary distributed system 200 for implementing cloning operations will now be described. The system 200 includes a first processor 202 which represents a database component of the distributed system 200. The system 200 also includes a second processor 220, which represents an application component of the distributed system 200. It will be understood by those skilled in the art that the processors 202 and 220 may reside on a single enterprise system (e.g., a mainframe computer) or may be operating in physically and geographically disparate locations (e.g., over a local area network). In addition, the processors 202 and 220 may be physically connected through cabling or may be in communication over one or more networks (wireless and/or wireline).

The database component 202 includes a database 204 that stores master data 206, user data 208, and application context data 210 (a database component-persistent part). The master data may include non-transactional data entities of an organization, which typically do not change, and which are often shared over a number of systems (e.g., data of assets of a company). User data may include transactional data of the application, which change during use of the system (e.g., business-relevant data, such as order processing data).

The application component 220 of the system 200 includes a file system 222, which in turn, includes at least one application 224, logistics context information 226 (a static application component-persistent part), and run time context information 228 (a dynamic application component-persistent part). The existence of significance of each single context (210, 226, 228) in regard to relevance for the system state depends on the type, nature, and implementation of the product.

One or more user systems 250 (e.g., computer processors operated by developers) and one or more systems 260 (remote computer systems, peripheral devices, etc.) may be in communication with the application component 220.

In an exemplary embodiment, a cloning application 262 is stored and executable by one or more of the systems 260. The application 262 implements the exemplary cloning operations described herein. It will be understood by those skilled in the art that the cloning application 262 may be implemented via alternative devices (e.g., cloning application 262 may reside on one of the user systems 250, or other device in communication with the distributed system 200).

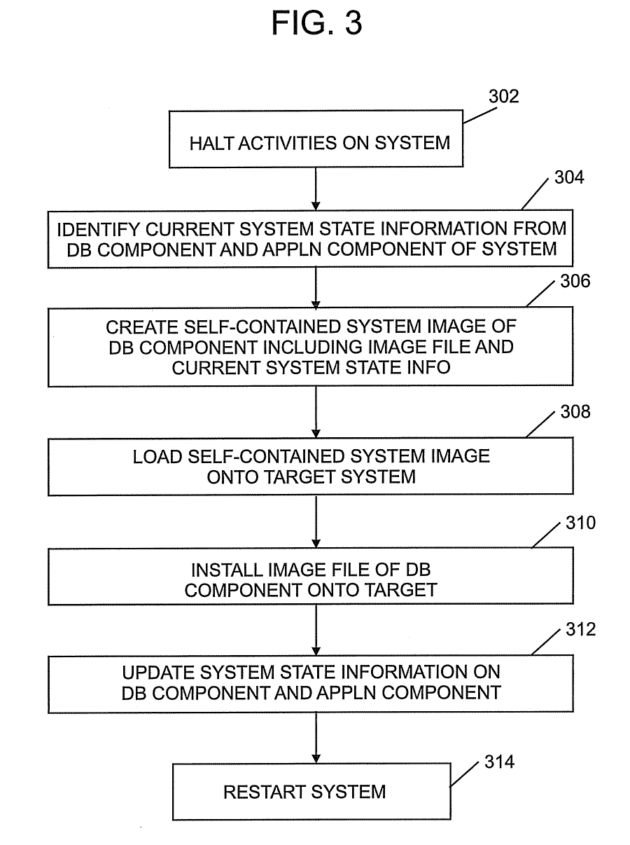

Operation of the cloning application 262 will now be described with reference to FIGS. 2 and 3. A source system is prepared for the system cloning operation via steps 302 through 306. The system 200 is then cloned at a target system via steps 308-314 as described in FIG. 3. The application logic is stateless and can be recreated for every clone from ‘scratch’ or using a stateless cloning method.

As indicated above, the system 200 is prepared for the cloning operation. This preparation includes halting activities occurring on the system 200 except for the cloning operation at step 302. For example, network traffic or operations on either of the database or application side are stopped. The database component 202 is available only for the cloning preparation.

At step 304, current system state information is acquired by the cloning application 262. The current system state information includes application context information 210 stored in the database component 202, and also logistics context information 226 and run time context information 228 stored in the application component 220. The application context information 210 may include application-related information including log file location, file system structure, and customization. The logistics context information 226 may include application-related local customization information relating to file systems and configuration. The run time context information 228 may include information produced during run time including log files and data described the progress of system use. The current system state information may be stored by accessing a function STORE SYSTEM STATE 230 via the application 224.

At step 306, a self-contained system image 264 is created by the cloning application 262. The self-contained system image 264 includes an image file of the database component 202 and the current system state information. The current system state information that was acquired in step 304 may be stored in a system state container 212 residing in the database component 202.

The system cloning may be initiated via a function RESTORE SYSTEM STATE 232 accessed via the application 224. At step 308, upon initiating this function, the self-contained system image 264 is loaded onto the target system (database component 202). The image file of the database component 202 is installed on the target system at step 310 and the system state information on the database component (application context 210) and on the application component (logistics context 226 and run time context 228) is updated at step 312. The system components 202 and 220 are then restarted at step 314.

In one embodiment, the system state container 212 is created in the database component 202 and stores the current system state information therein prior to the cloning application 262 creating the self-contained system image.

In another embodiment, a cloneable image flag field is provided in the database 204 and may be set to specify whether an image file is cloneable or not. The flag field 204 may be checked prior to restoring the system state of the application component 220 (e.g., prior to step 308) and restoring the system state only when it is determined that the image file is cloneable.

As described above in FIGS. 2 and 3, the self-contained system image is stateful. However, a stateless application image may be derived, e.g., from the application 224, from another application (not shown), or via some installation operation.

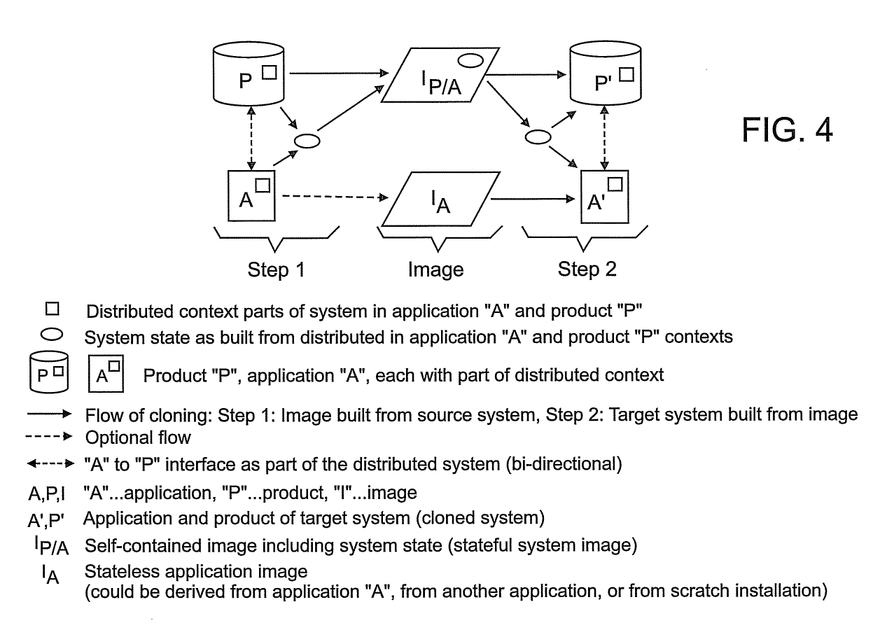

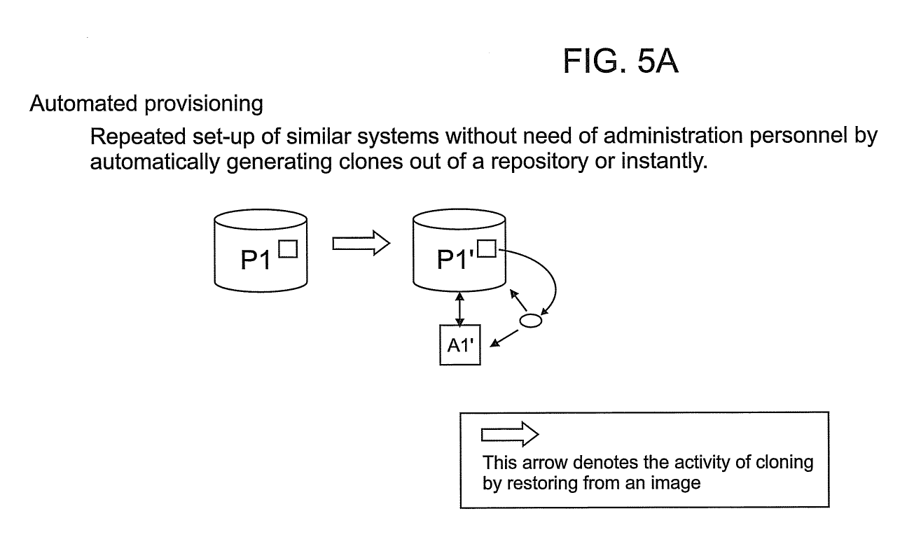

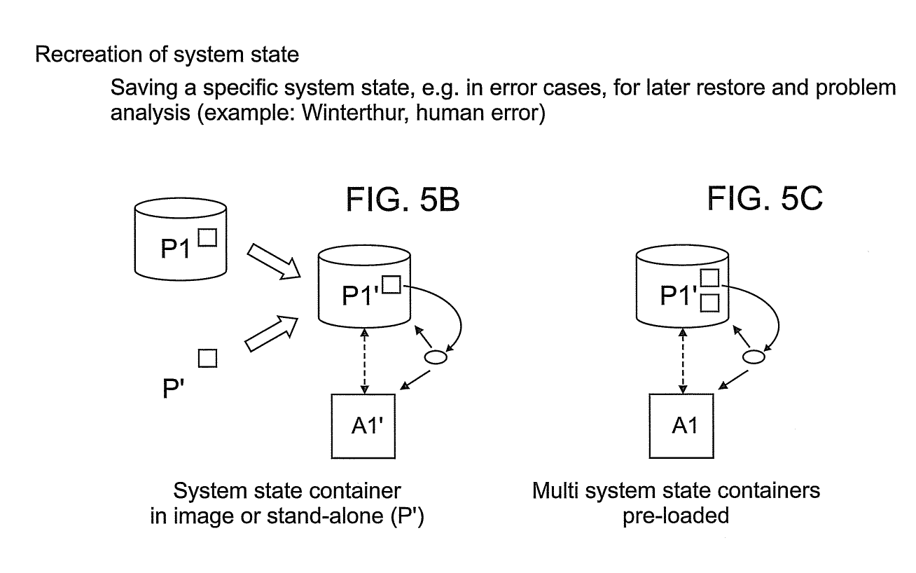

The system and processes described in FIGS. 2 and 3 are exemplified in a block diagram illustrated in FIG. 4. A process flow including two steps (step 1 corresponding to the cloning preparation process and step 2 corresponding to the restore process). FIG. 5A illustrates an application of the process described in FIGS. 3 and 4 and describes an automated provisioning application. FIG. 5B refers to a scenario, e.g., in which a cloneable image is created in house (e.g., product developer) for a customer. If a problem occurs with the customer's product, a system state container, extracted from a self-contained image or created otherwise, may be sent to the developer. The container includes no data or operations that may be confidential or protected. The system state container may then be used by the developer in house in order to re-create the problem scenario and debug the product. FIG. 5C illustrates multiple system state containers in a product in house such that a different operation mode may be created and various different tasks, e.g., performance tests could be performed (e.g., may select which system state container is active in a group). It will be understood that the various applications described in FIGS. 5A through 5C are provided for illustrative purposes and are not intended to limit the scope of the invention.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of implementing cloning operations in a distributed computing system, the method comprising:
preparing a database component of the system for a cloning operation, comprising:
stopping activities occurring on the system except for the cloning operation;
identifying current system state information from the database component and an application component of the system; and
creating a self-contained system image of the database component that includes an image file of the database component and the current system state information;
restoring the system state of the application component by loading the self-contained system image on the database component, installing the image file of the database component on the database component, and updating the system state information on the database component and the application component from the self-contained system image; and
restarting the system.

2. The method of claim 1, wherein the system state information includes:
application context information stored in the database component; and
logistics context information and run time context information stored in the application component.

3. The method of claim 2, wherein:
the application context information includes application-related information including log file location, file system structure, and customization;
the logistics context information includes application-related local customization information relating to file systems and configuration; and
the run time context information includes information produced during run time including log files and data described the progress of system use.

4. The method of claim 1, further comprising:
creating a system state container in the database component and storing the system state information in the system state container prior to creating the self-contained system image.

5. The method of claim 1, further comprising:
setting a flag in the database component indicating whether the image file in the database component is cloneable; and
checking the flag before restoring the system state of the application component and, only upon determining from the flag that the image file is cloneable, restoring the system state.

6. The method of claim 1, wherein the self-contained system image is stateful.

7. The method of claim 1, wherein the database component is implemented via a first processor in the system and the application component is implemented via a second processor in the system.

8. A system for implementing cloning operations in a distributed computing system, the system comprising:
a first processor implementing a database component;
a second processor in communication with the first processor, the second processor implementing an application component; and
a cloning application executing on a computer device, the cloning application in communication with the first and second processors, the cloning application implementing a method, comprising:
preparing the database component of the system for a cloning operation, comprising:
stopping activities occurring on the system except for the cloning operation;
identifying current system state information from the database component and the application component of the system; and
creating a self-contained system image of the database component that includes an image file of the database component and the current system state information;
restoring the system state of the application component by loading the self-contained system image on the database component, installing the image file of the database component on the database component, and updating the system state information on the database component and the application component from the self-contained system image; and
restarting the system.

9. The system of claim 8, wherein the system state information includes:
application context information stored in the database component; and
logistics context information and run time context information stored in the application component.

10. The system of claim 9, wherein:
the application context information includes application-related information including log file location, file system structure, and customization;
the logistics context information includes application-related local customization information relating to file systems and configuration; and
the run time context information includes information produced during run time including log files and data described the progress of system use.

12. The system of claim 8, wherein the cloning application further performs:
creating a system state container in the database component and storing the system state information in the system state container prior to creating the self-contained system image.

13. The system of claim 8, wherein the cloning application further performs:
setting a flag in the database component indicating whether the image file in the database component is cloneable; and
checking the flag before restoring the system state of the application component and, only upon determining from the flag that the image file is cloneable, restoring the system state.

14. The system of claim 8, wherein the self-contained system image is stateful.

15. A computer program product for implementing cloning operations in a distributed computing system, the computer program product including a storage medium with computer-executable program code embodied thereon, the program code including instructions for implementing a method, the method comprising:
preparing a database component of the system for a cloning operation, comprising:
stopping activities occurring on the system except for the cloning operation;
identifying current system state information from the database component and an application component of the system; and
creating a self-contained system image of the database component that includes an image file of the database component and the current system state information;
restoring the system state of the application component by loading the self-contained system image on the database component, installing the image file of the database component on the database component, and updating the system state information on the database component and the application component from the self-contained system image; and
restarting the system.

16. The computer program product of claim 15, wherein the system state information includes:
application context information stored in the database component; and
logistics context information and run time context information stored in the application component.

17. The computer program product of claim 16, wherein:
the application context information includes application-related information including log file location, file system structure, and customization;
the logistics context information includes application-related local customization information relating to file systems and configuration; and
the run time context information includes information produced during run time including log files and data described the progress of system use.

18. The computer program product of claim 15, further comprising instructions for implementing:
creating a system state container in the database component and storing the system state information in the system state container prior to creating the self-contained system image.

19. The computer program product of claim 15, further comprising instructions for implementing:
setting a flag in the database component indicating whether the image file in the database component is cloneable; and
checking the flag before restoring the system state of the application component and, only upon determining from the flag that the image file is cloneable, restoring the system state.

20. The computer program product of claim 15, wherein the self-contained system image is stateful.
